(19) United States
(12) Patent Application Publication
(10) Pub. No.: US 2006/0142988 A1
(43) Pub. Date: Jun. 29, 2006

(54) Design methodology and manufacturing method for semiconductor memory

(76) Inventors: Satoru Akiyama, Kawasaki (JP); Tomonori Sekiguchi, Tama (JP); Takayuki Kawahara, Higashiyamato (JP); Kazuhiko Kajigaya, Iruma (JP)

Correspondence Address: REED SMITH LLP, Suite 1400, 3110 Fairview Park Drive, Falls Church, VA, 22042, US

(21) Appl. No.: 11/318,431

(22) Filed: Dec. 28, 2005

(30) Foreign Application Priority Data
Dec. 28, 2004 (JP) 2004-379071

(51) Int. Cl. G06F 17/50

(52) U.S. Cl. 703/14

(57) ABSTRACT

A manufacturing method for semiconductor memory and a semiconductor design device, which can facilitate design and reduce a period of time required for the design, are provided. For example, when a designed memory array is verified, a read-out signal of a memory cell formulated by functions of respective parameters having various distributions is used. A value of the read-out signal is calculated by using a value extracted randomly from the distribution for each kind of parameter. Quality of the memory cell is determined from a calculated result. Calculation of the value of the read-out signal and determination of the quality of the memory cell are carried out to a great number of memory cells the memory array has. The total number of failed bits and the like obtained from these is used as an evaluation criterion.

### CROSS-REFERENCE TO RELATED APPLICATION

The present application claims priority from Japanese patent application No. JP 2004-379071 filed on Dec. 28, 2004, the content of which is hereby incorporated by reference into this application.

### BACKGROUND OF THE INVENTION

The present invention relates to a manufacturing method for a semiconductor memory and a design methodology for the same and particularly to a manufacturing method for a semiconductor memory and a design methodology for the same, which can effectively calculate the total number of failed bits in the semiconductor memory to derive therefrom optimum design and manufacturing method.

The present inventors have examined a design technique currently used for the semiconductor memory and found out the following problems.

For example, many Dynamic Random Access Memories (hereinafter abbreviated as “DRAMs”), which are one of semiconductor memory devices, are incorporated in various electronic equipment used in every day life. In order to satisfy needs of less power consumption and high performance, excellent characteristics of making power consumption small, speed high, and capacity high are required for the DRAM used in such electronics.

One of the most effective methods of realizing the DRAM with high performance is to miniaturize memory cells. The size of the memory cell can be reduced by miniaturization. As a result, data line length is shortened and parasitic capacitance of data lines is also reduced, so that a low-voltage operation can be performed and making the power consumption low can be achieved. In addition, as the parasitic capacitance of data lines is reduced, a sense amplifier operation (read-out operation) can be performed at high speed. Furthermore, as the memory cell becomes small, the memory capacity can be made large, whereby high performance of the device can be achieved. Thus, miniaturization significantly contributes to making the performance of the DRAM high.

However, as the miniaturization is made from a 65 nm node to a 45 nm node, a various side effects are revealed in addition to the above effect of the high performance. One of such side effects is to increase a fluctuation in device parameters (characteristics) caused by the miniaturization. Here, the fluctuation in device parameters includes, for example, a variance (deviation from average) in of values of threshold voltages or leakage currents leaking from the cell transistor. Since this fluctuation in device parameters affects circuit performance, the fluctuation is preferably minimized as few as possible.

The fluctuation in device parameters is caused by manufacture errors in, for example, channel length, channel width, thickness of a gate insulation film, which constitute a transistor device. The methods of seeking the fluctuation in device parameters such as threshold voltages caused by the manufacture errors and of obtaining a guideline for reducing the fluctuation include techniques disclosed in Patent Document 1 (Japanese Patent Laid-Open Publication No. 9-171522) and Patent Document 2 (Japanese Patent Laid-Open Publication No. 9-171521). Alternatively, Patent Document 3 (Japanese Patent Laid-Open Publication No. 2003-316849) discloses a method of modeling statistically the device characteristics and seeking probabilities of defects in timing requirement points in a chip. Alternatively, Patent Document 4 (Japanese Patent Laid-Open Publication No. 2002-318829) discloses a method of introducing the fluctuation in device parameters into a circuit simulation and seeking any fluctuation in circuit parameters at a specific point.

The increase of the fluctuation in device parameters becomes a cause of false operations at a time of reading signals from a DRAM cell. Its reason is that a so-called read-out signal Vsig of the DRAM is decreased by the fluctuation in device parameters. For example, as to the DRAM, a difference between threshold voltages (offset voltage) of a pair transistor configuring a sense amplifier circuit, leakage currents flowing from a memory cell transistor, or the like are main factors of decreasing the read-out signal. (Hereinafter, such factors are collectively referred to as “noise”.) Note that the examples of various cases of the decrease in the read-out signals are detailed in Non-Patent Document 1 (Kiyoo Itoh, Springer “VLSI memory chip design” p. 195-248, Apr. 1, 2001).

### SUMMARY OF THE INVENTION

The inventors have examined the design techniques for semiconductor memory as described above and consequently the followings have become apparent.

As memory capacity recently approaches to about 1 Gb, the noise becomes tremendously high in the worst case of being calculated based on the fluctuation in device parameters and the number of the devices. As a result, the read-out signal Vsig from the memory cell in the worst case may be 0. Conventionally, in order to read such a worst cell without performing the false operation, memory designers calculate worst conditions for a variety of noises, respectively, and design memory arrays to ensure the read-out signal Vsig by assuming that the conditions are satisfied simultaneously. An example of worst-case design includes, in order to ensure fully the read-out signal Vsig, setting a memory array voltage VDL higher than usual, making the memory cell capacitance sufficiently large, or shortening the data line length.

In the generation in which the miniaturization does not advance so, e.g., a 0.25 μm technique etc., the fluctuation in device parameters is also small and the array voltage VLD or cell capacity obtained from the worst-case design has such a value as not to lose reliability of a cell transistor or cell capacitor. However, when the noise is calculated in view of the worst case of the memory cell at a time of miniaturization, the design requirement for the array voltage VDL and cell capacitance CS obtained by using said design method may have unrealistic values. Thus, the present inventors have examined a statistical design approach as shown in FIGS. 1A and 1B.

FIGS. 1A and 1B are graphs showing a difference between a conventional worst-case design approach and the statistical design approach which is a fundamental concept of the present invention. FIGS. 1A and 1B represent the same data in different formats. Horizontal axes of the graphs represent offset voltages and leakage currents, which are noises, respectively, and vertical axes represent their frequencies. For example, when it is assumed that the memory capacity is 1 Gb (=M), the reference symbol “M” in the Figure is about 10⁹ and “N” is about 10⁶.

Conventionally, in estimating the noise in the worst cell (frequency 1), the worst-case design which supposes each worst case is commonly used. In this case, if it is assumed that each noise has an independent distribution, its occurrence probability is PW=1/(MN) obtained from a product of the offset-voltage-worst occurrence probability 1/N and the leak-current-worst occurrence probability 1/M. Thus, since each noise has the worst value, a total noise amount becomes a tremendous value.

As discussed below, the array voltage VDL for compensating for the worst cell calculated from the worst-case design in 1 Gb becomes 4.5 V. This becomes a value of the unrealistic design requirement from the viewpoint of reliability and power consumption. Meanwhile, in an actual chip, the worst-cell occurrence probability PW is 1/M. That is, the occurrence probability in the worst-case design is ˜ 1/10¹⁵, and is 1/10⁹ in the actual chip. It is understood that it is assumed that the memory cell with the occurrence probability smaller in about 6 digits is the worst cell in the conventional design.

Thus, in the method of designing the memory arrays under extraordinary stringent conditions, the worst condition of the memory cell in the actual chip cannot be accurately reflected, and the performance of the designed array cannot be quantitatively evaluated. Therefore, in order to evaluate accurately the performance of the designed memory array, a design approach of statistically modeling the fluctuation in respective noises to quantitatively calculate noises in the actual worst cell may be of great importance from this time.

As means for solving the above problem, the above Patent Document 3 discloses a method of formulating a delay time, assuming that respective parameters have the same normal distribution, and obtaining an expectation and a variance for a distribution of a sum of respective parameters from a so-called arithmetic mean and sum of variations. However, the above-mentioned technique is only applicable to a sum of reproductive distribution curves such as a sum of normal distribution curves or poisson distribution curves. Accordingly, as in the case of the distribution of the actual device parameters, a probability distribution with poor timing cannot be obtained in view of a plurality of fluctuation in devices with different distribution.

Alternatively, the above Patent Document 4 discloses a method of reproducing the fluctuation in device parameters (threshold voltages etc.) based on the manufacture fluctuation in the device parameters of channel length or channel width and of deriving circuit characteristics. However, when the circuit characteristic obtained at a predetermined position does not satisfy specification requirement, it cannot be specified which fluctuation in device parameters among the plurality of fluctuation in device parameters cause a defect in the circuit characteristic. The reason is that the method is not formulated and therefore an influence of each fluctuation in device parameters on the circuit characteristics cannot be quantified.

Therefore, in view of the above problem, an object of the present invention is to provide a manufacturing method for semiconductor memory and a semiconductor design device, which can facilitate design and reduce a period of time required for the design.

The above and other objects and novel features will become apparent from the description of the present specification and the accompanying drawings.

Outlines of representative ones of the inventions disclosed in the present application will be briefly described as follows.

A manufacturing method for a semiconductor memory according to the present invention comprises the steps of: designing a memory array containing a memory cell; verifying said designed memory array; and forming said verified memory array on a semiconductor wafer. In addition, the step of verifying said memory array includes: a first step of determining, with respect to a plurality of parameters each serving as a component for defining a characteristic of said memory cell and having a statistical distribution by assuming each manufacture fluctuation, each value of the parameters based on a random number in the distribution per set of said plurality of parameters; a second step of providing a formula defining the characteristic of said memory cell, and applying the value of each of said determined parameters to said formula to calculate the characteristic of said memory cell; and a third step of determining quality of said memory cell based on the characteristic of said calculated memory cell, wherein said first to third steps are performed to each of a plurality of memory cells said memory array contains. Further, such a step of verifying the memory array is realized by a computer processing of the semiconductor design device.

That is, for example, if the DRAM is taken for an example, the read-out signal of the memory cell can be formulated as the function of various parameters (leakage current, capacitance, offset voltage of a sense amplifier, or the like). However, in fact, each of the various parameters has a distribution depending on manufacture fluctuation. Thus, a value is randomly extracted from the fluctuation distribution for every parameter, and the read-out signal of the memory cell is calculated by applying the extracted value. Further, the extraction of such value and the calculation of the read-out signal are carried out to the plurality of memory cells the DRAM contains. Concurrently, the quality of each memory cell is determined based on the read-out signal thus calculated.

By providing the verification step as above, the semiconductor memory can be verified under a condition of having a characteristic nearer to a characteristic of an actually manufactured semiconductor memory has. That is, the design condition can avoid being excessively stringent similarly to the worst-case design that is the conventional technique. Moreover, since the verification can be made based on the determination result of the quality of each memory cell, the memory array can be quantitatively evaluated.

Furthermore, it can be verified by, for example, the number of memory cells determined as failure or the like, how each parameter affects the characteristic of the memory array. Therefore, it can be easily grasped which parameter is most effective in order to improve the characteristic of the memory array. In this case, for example, it is preferable as the verification result to display visually the distribution of each parameter and the quality determination result corresponding thereto.

By using the present invention due to the foregoing description, it is possible to realize facilitation of the design of the semiconductor memory or reduction of a period of time needed for designing. Note that the present invention is applicable not only to the DRAM but also to many other semiconductor memories such as a SRAM or flash memory.

If effects obtained by representative ones of the inventions disclosed by the present application are briefly described, it is possible to realize the facilitation of the design of the semiconductor memory and the reduction of the period of time needed for designing.

### DESCRIPTION OF THE DRAWINGS

FIG. 1A is a graph illustrating a difference between a conventional worst-case design as a premise of the present invention and a statistical design approach as a basic concept of the present invention, wherein FIG. 1A represents the same data in different formats.

FIG. 1B is a graph illustrating a difference between a conventional worst-case design as a premise of the present invention and a statistical design approach as a basic concept of the present invention, wherein FIG. 1B represents the same data in different formats.

FIG. 2 is a flow chart for manufacturing a chip when a memory array is designed using conventional worst-case design.

FIG. 3 is a flow chart of manufacturing the chip when a design approach according to the present invention is applied to circuit design.

FIG. 4 is a view showing an example of a structure of a semiconductor design device realizing the design approach according to the present invention.

FIG. 5 is a view comparing and showing a processing outline of a signal to noise ratio calculation made by the conventional design approach and a signal to noise ratio calculation made by the design approach according to the present invention.

FIG. 6 is a view showing an example of a statistical distribution processing performed in setting an input device parameter in a processing of FIG. 5.

FIG. 7 is a view showing an example of a memory array constructed in the processing of FIG. 5.

FIG. 8 is a view showing an example of a signal to noise ratio calculation processing of the memory cell in the processing of FIG. 5.

FIG. 9 is a view showing an example of a processing for deriving the number of failed bits from the signal to noise ratio calculation in the processing of FIG. 5.

FIG. 10 is a graph showing an example of an output method for a result obtained from the signal to noise ratio calculation in the processing of FIG. 5.

FIG. 11 is a view showing a first embodiment of an evaluation result of array design by making concordant design for a 1-Gb memory cell using the design approach according to the present invention.

FIG. 12 is a view showing an embodiment of an analysis result of a characteristic of the memory cell disposed on a boarder line between a pass and a failure.

FIG. 13 is a view showing an embodiment of a result of analyzing quantitatively a cause of failed bits obtained by setting, to various values, input parameters shown in FIG. 6.

FIG. 14 is a view showing another embodiment of an output result of the signal to noise ratio calculation.

FIG. 15 is a view showing an embodiment of a result of calculating a total number of failed bits obtained by setting, to various values, the input parameters shown in FIG. 6.

FIG. 16 is a view an embodiment of a specific example of measures for remedying the failed cells based on the number of failed bits obtained by the method according to the present invention.

FIG. 17A is a view for explaining a case of applying the design approach according to present the invention to a SRAM, wherein FIG. 17A shows an example of a circuit diagram of the SRAM.

FIG. 17B is a view for explaining a case of applying the design approach according to present the invention to a SRAM, wherein FIG. 17B shows an example of an operating waveform thereof.

FIG. 18A is a view for explaining a case of applying the design approach according to the present invention to a NAND type non-volatile memory, wherein FIG. 18A shows an example of the circuit diagram of the NAND type non-volatile memory.

FIG. 18B is a view for explaining a case of applying the design approach according to the present invention to a NAND type non-volatile memory, wherein FIG. 18B shows an example of an operating waveform thereof.

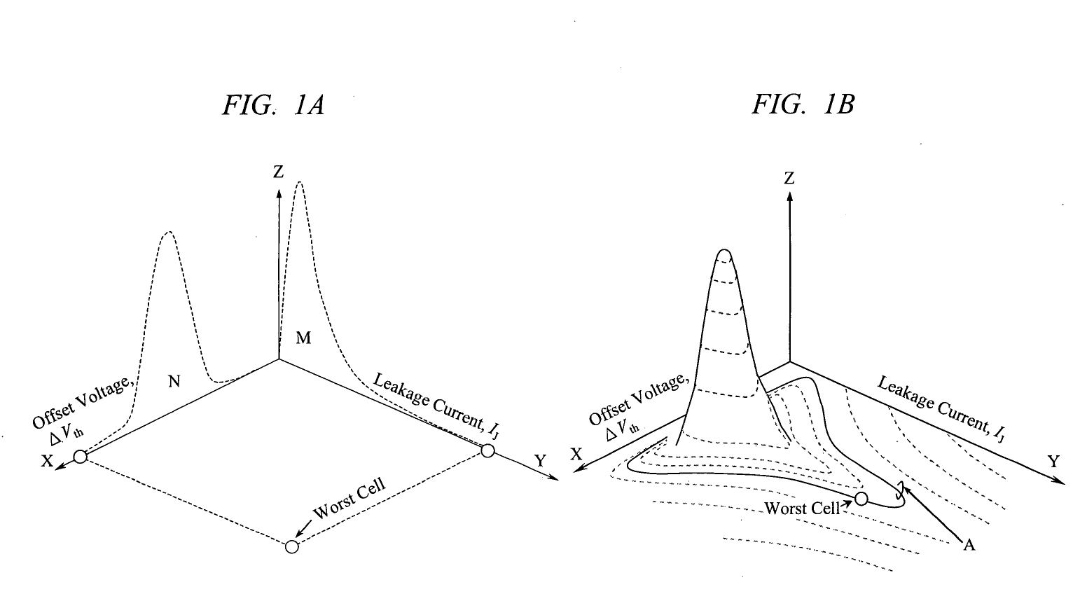

### DESCRIPTION OF THE PREFERRED EMBODIMENTS

Hereinafter, embodiments of the present invention will be detailed based on the drawings. Note that throughout all the drawings for explaining the embodiments, the same members are denoted in principle by the same reference numeral and the repetitive explanation thereof will be omitted.

A transistor configuring each block shown in the present embodiment is formed on a single semiconductor substrate such as monocrystal silicon by an integrated circuit technique such as a well-known CMOS (complementary MOS transistor) although not limited particularly thereto. That is, after a step of forming a well, a device isolation area, and an oxide film, the transistor is formed by a step including a step of forming a gate electrode and first and second semiconductor region configuring source and drain regions.

Among circuit symbols of a MOSFET (Metal Oxide Semiconductor Field Effect Transistor), the symbol having no circle at a gate represents an N-type MOSFET, which is distinguished from a P-type MOSFET (PMOS) represented by the symbol having a circle at the gate. Hereinafter, the “MOSFET” will be abbreviated as a “MOS” or “MOS transistor”.

Note that the present invention is not limited to a field-effect transistor containing an oxide film between a metal gate and a semiconductor layer, and is applicable to any circuits employing a common FET including a MISFET (Metal Insulator Semiconductor Field Effect Transistor), an insulation film being interposed between the MISFETs.

### First Embodiment

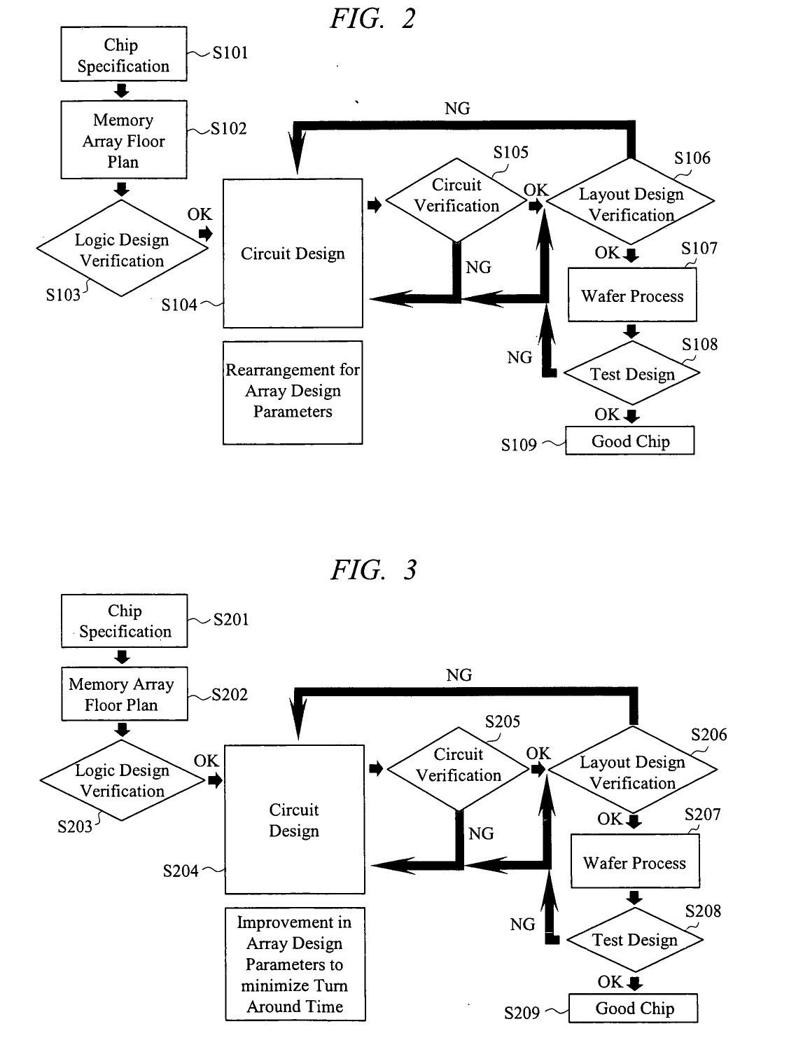

Next, a manufacturing method for semiconductor memory and a semiconductor design device, which is an embodiment of the present invention, will be described with reference to FIGS. 2 to 16.

First, with reference to FIGS. 2 and 3, respective manufacture flows are compared between the case of using the conventional technique and the case of using the present invention. FIG. 2 shows a chip manufacturing flow when the memory array is designed using the conventional worst-case design. FIG. 3 shows a chip manufacturing flow when the design approach according to the present invention is applied to the circuit design.

As shown in FIG. 2, when the conventional design approach is used, the specification of the chip is established in Step S101. Then, arrangement of circuit blocks in the memory array is determined in Step S102. Next, in Step S103, a logic operation of the memory array is designed with a hardware description language etc., and then is verified. Thereafter, in Step S104, a circuit capable of realizing a logic operation is designed using a transistor model. In Step S105, it is verified whether operating speed and operating timing of the circuit satisfies specification requirements. In this time, in accordance with the verified results of the circuit, there is performed a processing for seeking a parameter, which requires improvement for obtaining a desired specification among a plurality of array parameters.

After the design and verification of the circuit are completed, layout is designed and verified in Step S106. In this time, the procedure may be returned to the circuit design if necessary. After debugging, an actual chip is manufactured on a silicon wafer in Step S107. Finally, in S108, the manufactured chip is verified as to manufacture error or retention failure of the memory cell due of dependency on a data pattern, whereby the good chip which satisfies the specification requirement is selected.

Meanwhile, as shown in FIG. 3, when the design approach according to the present invention is used, as input parameters required to calculate the circuit characteristic a statistical distribution adequately expressing the actual distribution of the input parameters is used. Thus, a distribution of values of the desirable circuit parameters can be obtained. The total number of failed bits can be calculated from the outputted distribution. Furthermore, since the cause of the failed bit can also be analyzed, the array parameter to improve efficiently the design can easily be identified and a guideline for rearranging the memory array can be preliminary obtained. Therefore, the period time needed for designing can be significantly reduced. Note that the flow shown in FIG. 3 is the same as that shown in FIG. 2 except the Step S204 and so its explanation will be omitted.

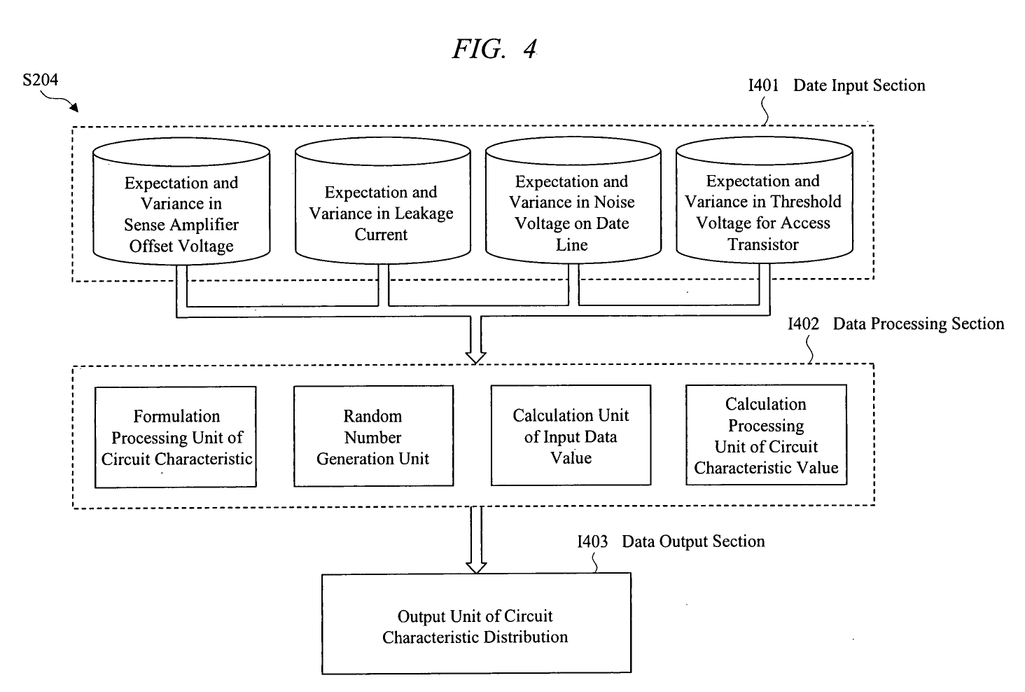

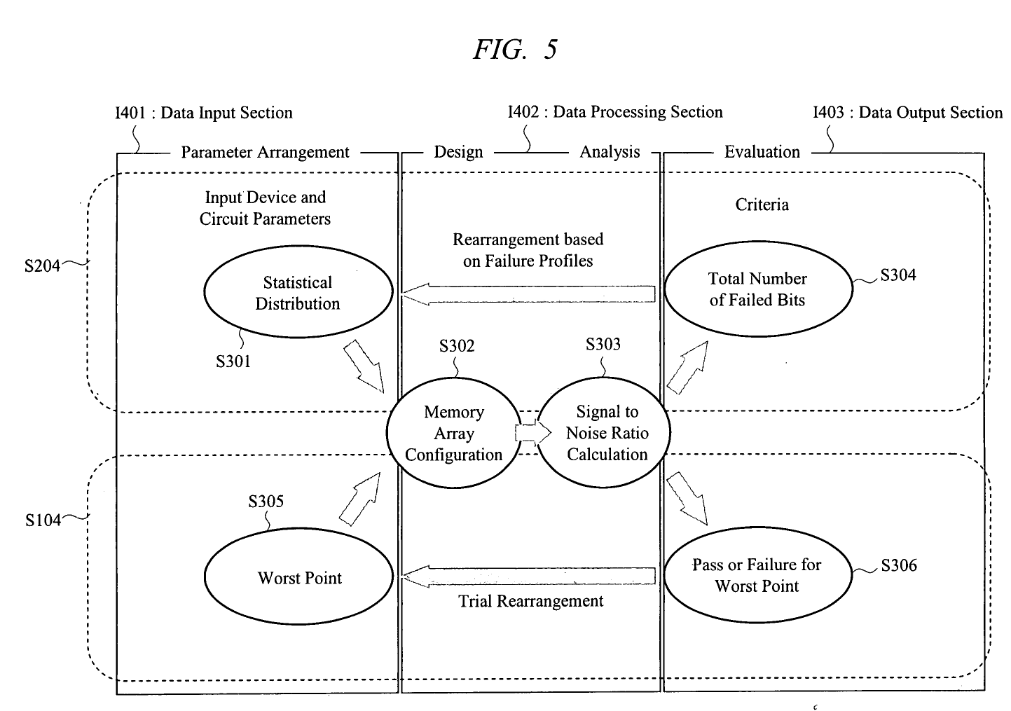

Next, with reference to FIGS. 4 and 5, an example of a device required for a processing of the Step S204 and a detailed example of the processing will be described. FIG. 4 is a view showing an example of a configuration of the semiconductor design device for realizing the design approach of the present invention.

The semiconductor design device shown in FIG. 4 comprises a data input section I401, a data processing section I402, and a data output section I403. As mentioned above, the input parameters required for calculating the circuit parameters have a certain statistical distribution. Herein, the statistical distribution means a distribution with certain frequency and certain width. FIG. 4 shows the case where, as input data, an offset voltage of a sense amplifier, a leakage current of an access transistor, a noise voltage on a data line, and a threshold voltage for access transistor each have a certain expectation and a certain variance. These input data are transmitted to the data processing section I402.

The data processing section I402 comprises a means of formulating a desirable circuit parameter, a means of generating such a random number as to reproduce a statistical distribution the input data follows, a means of calculating the offset voltage value and the leakage current of a sense amplifier from the generated random number, and a means of substituting a value such as a leakage current generated at random into an equation of the formulated circuit characteristic and of calculating a desirable circuit characteristic value. The data output section I403 has a means of outputting the circuit characteristic distribution for outputs all the calculated circuit characteristic values as a distribution having certain frequency and certain width. Thereby, for example, a read-out signal development time of the memory cell and the total number of failed bits having the data retention time less than required can be calculated.

Note that the semiconductor design device can be realized by a program processing using a computer. That is, for example, for various pieces of data in the data input section I401 stored in a memory such as a hard disk, a processing by the data processing section I402 is performed using a CPU and RAM, etc. and various pieces of distribution data that are a processing result are outputted on a display etc.

FIG. 5 is a view comparing and showing respective processing outlines of the case of making the signal to noise ratio calculation by the conventional design approach and the case of making the signal to noise ratio calculation by the design approach according to the present invention.

In the conventional method, the input parameter values (such as an offset voltage of the sense amplifier or leak current of the access transistor) for making the signal to noise ratio calculation are a worst value (S305) calculated based on the total number of memory cells and/or the fluctuation in device parameters (input parameters). Therefore, when the signal to noise ratio calculation of a certain memory array configuration designed in step S302 is made (Step S303), the quality of the array is evaluated by the above-mentioned worst case (Step S306).

However, as mentioned above, the occurrence probability of the input parameter of the memory cell calculated in the worst-case design is remarkably small, the read-out signal calculated in Step S303 is equal to or less than 0 (zero), and a read-out error in the memory cell occurs in some cases. In this case, it is necessary to rearrange the memory array so that the memory cell at a worst point may not fail. However, in the worst-case design in which an excessively stringent condition is supposed, a reduction of the fluctuation in device parameters required in the rearrangement may become physically difficult in some cases. As a result, there is any fear of the fact that the good chips satisfying the specification requirement cannot be obtained.

Furthermore, since the conventional design approach has no means of formulating the circuit characteristic (i.e. read-out signal) Vsig in the form of incorporating the fluctuation in the plurality of device parameters with different distributions, it cannot be quantified how the respective parameter values of the plurality of device parameters influence the circuit characteristics. Therefore, all the possible device characteristic parameters are rearranged and confirmation of their improvement effects and byproducts has to be verified by a circuit simulation and an actual chip, thereby resulting in an increase in times required for the whole chip design.

As a matter of course, such a circumstance is not limited to a stage of the circuit design. Needless to say, the same is likely to occur even in the circuit verification, layout design/verification, or test design. For example, it is assumed that the actual chip is proved to satisfy no desirable operating speed in the test design. Measures for increasing a drive current in the memory cell and making the read-out speed high are recited as an example of rearrangement.

Specifically, if channel width of the memory cell transistor is made large, the drive current can be increased. In view of cost at this time, it is desirable to increase the channel width of the memory cell without increasing the chip size. However, if the channel width is increased with the chip size being constant, a distance between the memory cells becomes narrow. As a result, it is likely to increase an occurrence frequency of contact failure (layout failure) or to bring an increase of the leakage current etc. due to an increase of a stress between the transistors, which is caused by the fact that the distance between the memory cells has been narrow. Of course, the above-mentioned rearrangement may be made by ensuring the large distance between the memory cells. However, in this case, the byproduct, i.e., the increase in the chip size may occur.

Thus, it is necessary to take into consideration not only the improvement effect of the increase in the drive current but also trade-off of an increase in failure percentages or chip size caused by enlarging the channel width. Therefore, in being rearranged at various steps, all the possible trade-offs must be verified by a simulation or an actual chip, so that the time required for making the chip design is inevitably increased.

Meanwhile, the concordant design technique that is a concordant design methodology according to the present invention is realized by, for example, the device shown in FIG. 4. In this concordant design technique, a parameter having a statistical distribution is used as a device parameter or circuit parameter that is an input parameter, in the step S204 of the circuit design. Here, preferably the input parameter has a distribution well suitable for the actual device and circuit characteristics. For example, the input parameters are set so that the offset voltage of the sense amplifier follows in the form of a normal distribution, the leakage current follows in the form of a log-normal distribution, and the array noise follows in the form of a uniform distribution (Step S301).

After designing the desired memory array (Step S302), a noise component of the memory cell per bit is generated in accordance with the statistical distribution of the input data set in the Step S301 in the data processing section I402. That is, the read-out signals Vsig of all bits are calculated per bit (S303). After calculating the read-out signal of the memory cell per bit, the total number of failed bits that is a criterion of the quality of the array is calculated in the data output section I403 (S304). Herein, the “failed bit” means a memory cell to be a read-out error and, for example, is a memory cell in which, after the data retention time required from the specification has elapsed, the read-out signal Vsig outputted to the data line is equal to or less than 0 (zero).

In this way, sine the read-out signals Vsig are calculated for all the bits, the memory cell characteristic of the worst cell (frequency 1) in the actual chip can be reproduced. In other words, when an influence on the circuit characteristic is calculated in view of the fluctuation in device parameters, a method of combining the fluctuation in parameters can be generated so as to reproduce the actual device. For example, the offset voltage of the sense amplifier has a value of about expectation (occurrence probability: ˜0.5) and the leakage current of the memory cell can be calculated for all the bits by generating randomly the value of the device characteristic parameter such as a worst value (occurrence probability: ˜ 1/10⁹). Therefore, the actual worst case can be reproduced.

In addition, according to the approach of the invention, since the number of failed bits during any data retention times can be also quantified, the measures and techniques for satisfying the desirable specification can also be also identified. For example, when the total number of failed bits satisfying no data retention time required is more than the number of redundant bits mounted on the array, it is possible to make, from the total number of failed bits calculated by using the present concordant design methodology, a determination of whether remedy capacity should be enhanced by increasing the redundant bits and sacrificing an increase of the chip size or whether cell capacity should be increased by several fF. Thus, the distribution of each device characteristic parameter can be statistically reproduced and the influence of each parameter on the circuit characteristic can be quantified, so that an optimum guideline in rearranging the designed memory array can be extracted and the period of time necessary for designing the circuit can be significantly reduced.

Note that although the concordant design technique has been mainly explained about the circuit design in FIG. 5, the present invention may, needless to say, be variously modified within the scope of not departing from the gist thereof. For example, as an input device characteristic parameter, there is provided a means of introducing parasitic resistance or parasitic capacitance of a wiring, a change in a power supply voltage, or the like to statistically calculate the physical location of the failed bit. In this case, since the physical position of the failed bit can be reproduced, the remedy measures with higher accuracy can be selected.

Moreover, the design approach of the present invention can be applied to the timing analysis in the circuit verification. For example, if the circuit verification is made by modeling the resistance and the parasitic capacitance of the wiring and by formulating the delay time at the desirable place, the memory array can be evaluated with higher accuracy in comparison with the conventional worst-case design of course, the design approach of the present invention can be applied to both circuit design and circuit verification. In this case, since the optimum array design satisfying the specification requirement can be realized, the period of time necessary for the design and the rearrangement in verification can be reduced by the necessary minimum.

Moreover, there may be provided a means of estimating an actual shape of a device from a layout pattern, e.g., a means of statistically reproducing a distribution of the transistor shape in the memory cell. In this case, a correlation between the drive current for memory cell and the leakage current obtained from the device shape is clarified. Therefore, the trade-off between the increase in the drive current in the memory cell and the percent of the failed cells can be quantified as described above, and the optimum guideline for rearrangement can be extracted. Therefore, the period of time necessary for turning back can be reduced. Thus, needless to say, by applying the concordant design technique according to the present invention to various flows of the memory array, the invention can obtain an effect of acquiring many good chips in a shorter period of manufacture time.

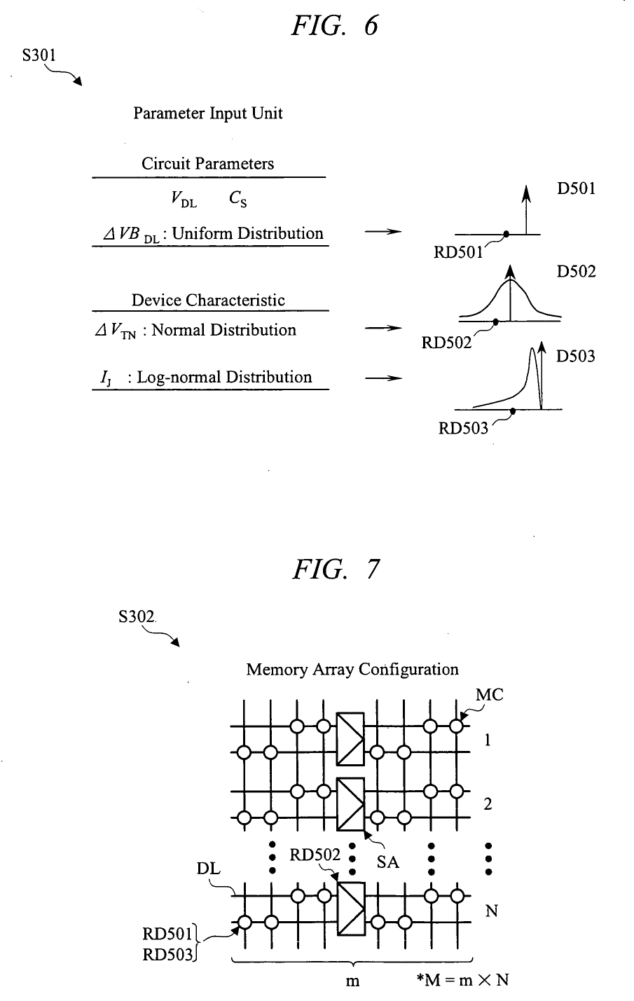

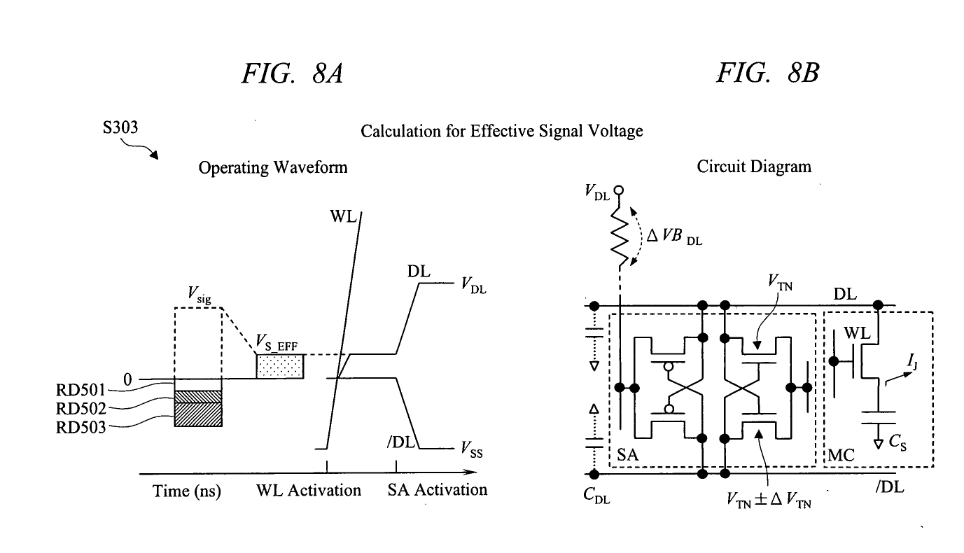

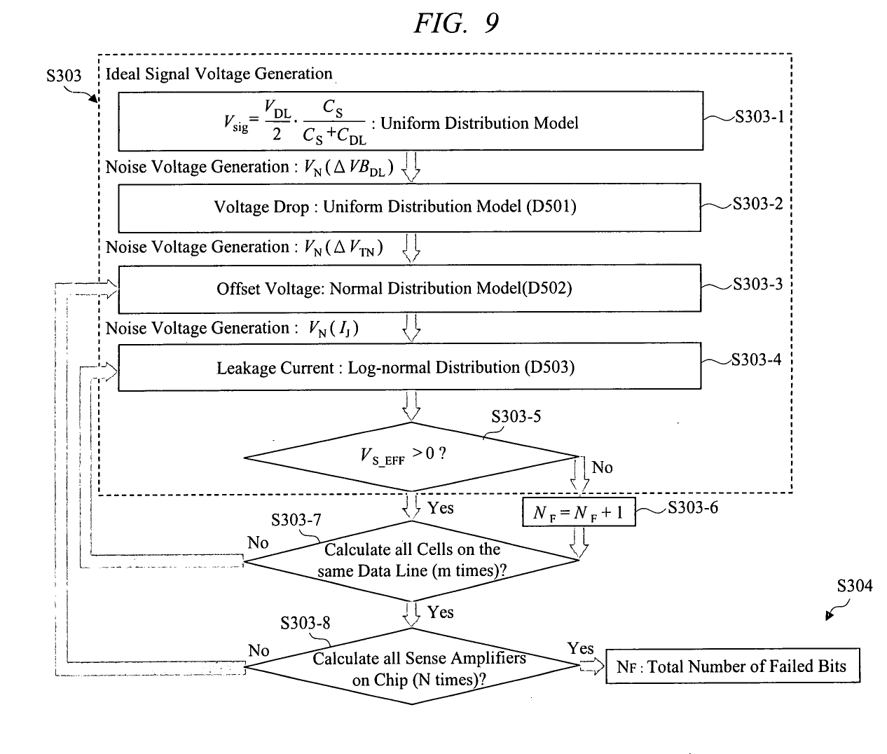

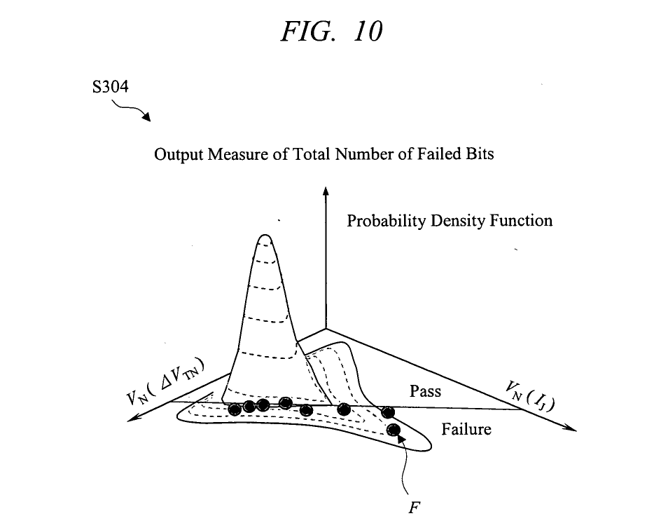

Next, an example of contents of detailed processings of Steps S301, S302, S303, and S304 in FIG. 5 will be described with reference to FIGS. 6 to 10. Herein, a description will be made on the assumption that the design approach according to the invention is applied to so-called signal design of the DRAM. FIG. 6 is a view showing an example of a processing of a statistical distribution performed when the input device parameters are set in the processing of FIG. 5. FIG. 7 is a view showing an example of a memory array configured in the processing of FIG. 5. FIG. 8 is a view showing an example of a signal to noise ratio calculation processing of the memory cell in the processing of FIG. 5. FIG. 9 is a flow chart showing an example of a processing performed in deriving the total number of failed bits from the signal to noise ratio calculation in the processing of FIG. 5. FIG. 10 is a graph showing an example of an output method of a result obtained by the signal to noise ratio calculation in the processing of FIG. 5.

First, input parameters necessary for signal design are set similarly to the Step S301 in FIG. 6. Herein, an array voltage VDL, a cell capacitor CS, and a supply voltage drop AVEDL are used as circuit parameters, and an offset voltage AVIN of the sense amplifier circuit and a cell leakage current IJ of the access transistor are used as device parameters. Note that other circuit parameters and device parameters, such as a word line voltage VWL and a threshold voltage VTH of the cell transistor, are omitted for sake of simplicity of the explanation.

In the above input parameters, the supply voltage drop ΔVBDL follows a uniform distribution D501 and takes a value of RD501, for example. The offset voltage ΔVTN follows a normal distribution D502 and takes a value of RD502, for example. The cell leakage current IJ follows a log-normal distribution D503 and takes a value of RD503, for example. As described above, each fluctuation in device parameters is randomly generated from each statistical distribution. That is, by using a distribution suitable for the distribution characteristic of the actual device as input parameters, the memory array can be quantitatively evaluated.

Next, a memory array configuration is designed as shown in Step S302 of FIG. 7. In the figure, the reference symbol “MC” represents a memory cell, “SA” represents a sense amplifier, “DL” represents a data line, “N” represents the number of sense amplifiers, “m” represents the number of memory cells on the data line, “M” represents total memory capacity, and “RD501” to “RD503” represent input parameters in FIG. 5. Note that although a so-called folded data-line array structure is shown in FIG. 7, this embodiment may be an open data-line array structure. The design approach according to the present invention can be applied to various array structures.

After designing the array structure, the read-out signals are analyzed in Step S303. As shown in the operating waveform of FIG. 8A, the ideal read-out signal Vsig(=(VDL/2)×CS/(CS+CDL)) is a minute voltage difference, which appears in the data lines DL and /DL, after activating the word line WL. This voltage difference is amplified to a ground voltage VSS, to which the array voltage VDL is grounded, by activating the sense amplifier circuit SA. Note that the circuit diagram of FIG. 8B is one used in a general DRAM and its detailed explanation will be omitted.

Herein, the ideal read-out signal Vsig decreases to an effective read-out signal VS_EFF due to the supply voltage drop ΔVBDL, the offset voltage ΔVTN, and the leakage current IJ and can be expressed as

$${V}_{S EFF} = \frac{{V}_{DL}}{2} \cdot \frac{{C}_{S}}{{C}_{S} + {C}_{DL}} - ( {V}_{N} ( Δ {VB}_{DL} ) + {V}_{N} ( Δ {V}_{TN} ) + {V}_{N} ( {I}_{J} ) ) , \qquad ( 1 )$$

where “CDL” is data line parasitic capacitance, “VN(ΔVBDL)”, “VN(ΔVTN)” and “VN(IJ)” are loss data-line signals when the values of the supply voltage drop ΔVBDL, the offset voltage ΔVTN, and the cell leakage IJ are converted into the data-line voltage at a time of read-out. The design approach according to the present invention calculates three fluctuations in device parameters (noise) in the right-hand-side parenthesis per bit in the memory cell and seeks an effective read-out signal VS_EFF for all the memory cells. Therefore, the total number of failed bits can be obtained, and the designed memory array can be quantitatively evaluated.

FIG. 9 is a flow chart showing a series of processings in the above Steps S303 to S304. The ideal read-out signal Vsig for a certain memory cell is calculated from the array voltage VDL, the cell capacitor CS, and the data line parasitic capacitance CDL (S303-1). Next, the values for VN(ΔVBDL), VN(ΔVTN), and VN(IJ) of the loss data-line signals which is a noise voltage component are generated randomly in accordance with the assumed statistics model (S303-2, S303-3, and S303-4). For example, a pseudo-random number generation means such as box Mueller method may be used to generate such a random number as to follow the normal distribution model.

Thus, three noise voltage components shown in the right-hand side of equation (1) are generated one by one for each memory cell. Then, an effective read-out signal VS_EFF is calculated by subtracting the three noise voltage components from the ideal read-out signal Vsig generated (S303-5). At this time, if the effective read-out signal VS_EFF is 0 (zero) or less, the number of failed bits NF is counted up (S303-6). The processings from Steps S303-4 to S303-7 are repeated for m times, “m” being equal to the number of memory cells connected to the same sense amplifier, whereby the effective read-out signal VS_EFF is calculated. Further, the processings from Steps S303-3 to S303-8 are repeated for N times, “N” being equal to the number of sense amplifier in the structured memory array, whereby the effective read-out signal VS_EFF is calculated in a same manner and the effective read-out signal VS_EFF and the number of failed bits NF for all memory cells are calculated (S304).

Next, in the Step S304, a means of outputting a result obtained from the signal to noise ratio calculation includes a graph in which, as shown in FIG. 10, an offset-voltage loss signal VN(ΔVTN) and a leakage-current loss signal VN(IJ) configuring the noise voltage are represented on respective horizontal axes and a frequency (synonymous with a probability density function) is represented on a vertical axis. The straight line which distinguishes the pass from the fail on the plane can be obtained by transforming the equation (1) to the following equation (2):

$${V}_{N} ( Δ {V}_{TN} ) + {V}_{N} ( {I}_{J} ) < \frac{{V}_{DL}}{2} \cdot \frac{{C}_{S}}{{C}_{S} + {C}_{DL}} - {V}_{N} ( Δ {VB}_{DL} ) . \qquad ( 2 )$$

In the Figure, points F plotted in a failed region represent failed bits.

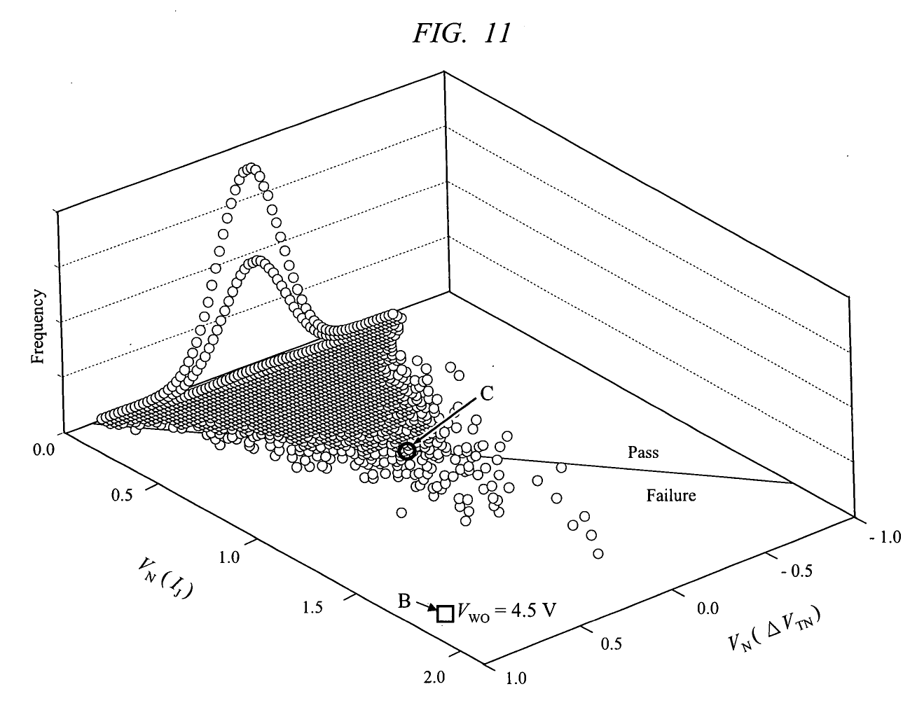

FIG. 11 is a specific example of an output result of FIG. 10, and is a result of the signal to noise ratio calculation made by the 1-Gb memory array using the design approach according to the present invention. The horizontal axes represent the offset-voltage loss signal VN(ΔVTN) and the leakage-current loss signal VN(IJ), and the vertical axis represents the frequency (the number of memory cells). The array voltage VDL is 1.4 V, the cell capacity CS is 25 fF, and the number of sense amplifiers N is about 1.5 M. In the folded data-line array structure, the data retention time of each memory cell was calculated from the above-mentioned effective read-out signal VS_EFF, and the number of failed bits in which the data retention time does not satisfy the specification requirement (e.g., 64 ms) was calculated. Consequently, the number of failed bits was 165 bits.

Here, the number of failed bits, i.e., 165 bits, is much smaller than the maximum number of remedy bits which can be mounted on a chip. Thus, by using the present method, it can be guaranteed that the 1-Gb memory array designed by the above-mentioned input setup operates in accordance with the specification requirement. Meanwhile, in the conventional worst-case design point, the worst array voltage VWO calculated from the worst value of each loss signal becomes 4.5 V. As understood from the foregoing description, the memory array can be quantitatively evaluated by providing a means of calculating the total number of failed bits, instead of the conventional method in which the performance of the memory array is evaluated based on the quality of the memory cell at the worst point.

Note that the graph in FIG. 11 is obtained from such an output means that it is clearly determined which noise voltages a main cause of the failed bit is based on. As shown in FIG. 11, it is understood that most failed bits are distributed within an area where the offset-voltage loss signal VN(ΔVTN) is around an exception of 0 (zero) and the leakage-current loss signal VN(IJ) is 1.0 or more (i.e., the effective read-out signal becomes 0 (zero) only by the leakage current). Therefore, in order to reduce the number of failed bits, it is more effective to reduce the fluctuation in leakage currents (reduce the fluctuation width of VN(IJ)) rather than to reduce the fluctuation in offset voltages.

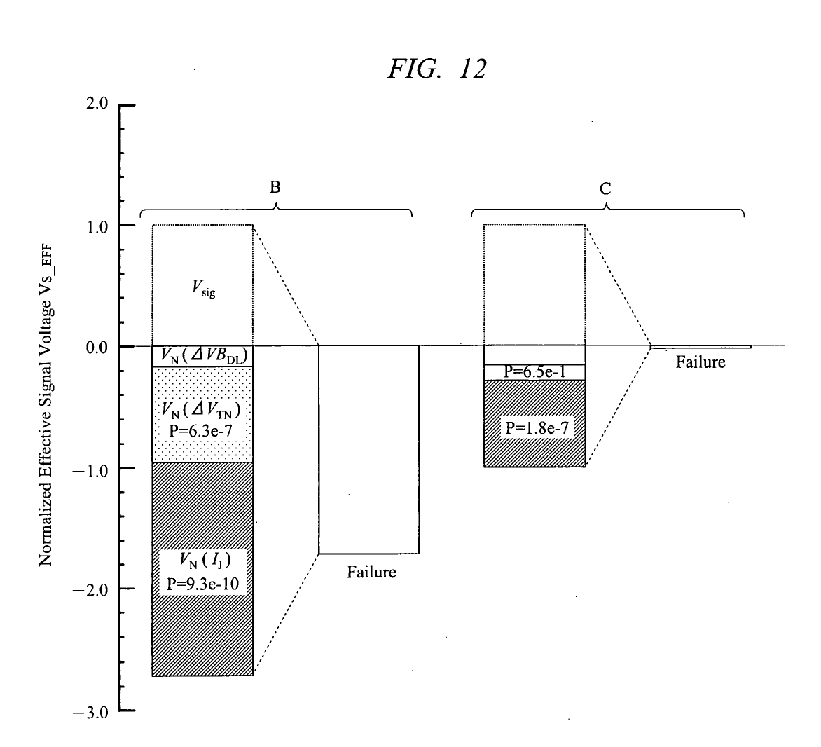

Furthermore, if a means of outputting a calculation result of the noise voltage component in each memory cell is provided, the specific failed bit can be profiled. FIG. 12 is an example showing an analysis result of the memory cell parameters on a border line between the pass and the failure in FIG. 11. FIG. 12 shows respective the effective read-out signals VS_EFF calculated by subtracting the noise voltage from the ideal read-out signal Vsig based on a noise-voltage calculated result at the worst-case design point B (point B in FIG. 11) obtained from the conventional worst-case design and based on a noise-voltage calculated result for a marginal failed bit C existing on the border line between the pass and the failure (C point in FIG. 11).

In the worst-case design as above, the occurrence probability of the offset-voltage loss signal VN(ΔVTN) and that of the leakage-current loss signal VN(IJ) are “6.3E-7” and “9.3E-10”, respectively. Therefore, the total noise is about 2.7 times of the ideal read-out signal Vsig and the worst cell becomes a retention failed bit. Meanwhile, the occurrence probability of the noise at the marginal failed bit calculated by using the design approach of the present invention is such that the offset-voltage loss signal VN(ΔVIN) becomes “6.5E-1” and the leakage-current loss signal VN(IJ) becomes “1.8E-7”.

It is clear from the above analysis result that the offset-voltage loss signal VN(ΔVTN) has a value near the expectation (loss signal 0 mV) serving as a design target, thereby being no main factor of the retention failed bit. Meanwhile, the fluctuation in leakage-current loss signal VN(IJ) is wide and occupies about 80% of the total loss signal. Thus, if the means of outputting the calculation result of the noise voltage component of the memory cell is provided as a means of outputting the analysis result according to the present design approach, the cause of the failed bit can easily be analyzed.

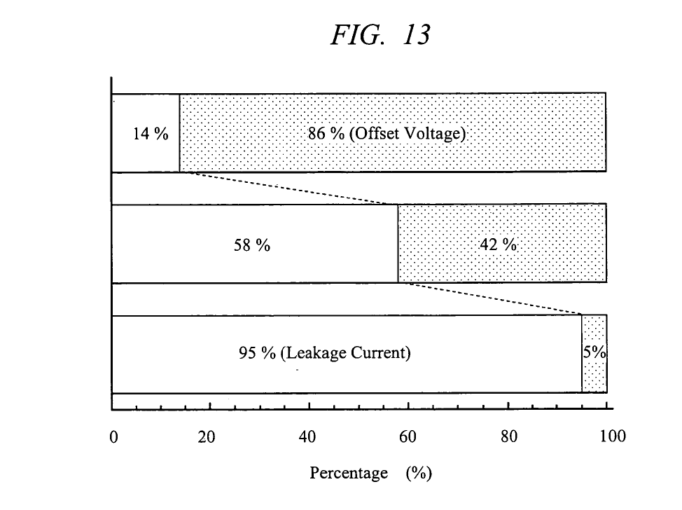

FIG. 13 shows an embodiment of a result obtained by setting the input parameters in FIG. 6 to various values and by analyzing quantitatively the cause of the failed bits. Herein, as a means of reproducing an output result other than that of FIG. 12 as described above, a means in which the offset voltage and the leakage current output percents contributing to the total number of failed bits is provided under the condition of various input parameters in FIG. 13. For example, for input setting in a bar graph at a top in FIG. 13, it is indicated that the number of memory cells which become failure due to the offset voltage occupies 86% of all the failed bits. In this case, it is understood that a reduction of the fluctuation in offset voltages is a technical problem. For input setting in a bar graph at a middle therein, 58% thereof become failure due to the leakage current and 42% thereof become failure due to the offset voltage. For input setting in a bar graph at a bottom therein, 95% thereof cause retention failures of the memory cell due to the leakage current.

As seen from the descriptions of FIGS. 11 to 13, the use of the design approach according to the present invention can quantitatively make a distinction of whether the fluctuation in leakage currents in the memory cell transistor is caused by the retention failure of the memory cell or whether the fluctuation in offset voltages in the sense amplifier is caused by the retention failure of the memory cell.

Of course, the analysis result can be transformed into various output formats for any purpose. FIG. 14 shows another embodiment of an output result of the signal to noise ratio calculation. The horizontal axis represents a data retention time tREF and the vertical axis represents a so-called retention distribution serving as a cumulative distribution. For example, when the maximum number of remedy bits which can be mounted on the chip is a percent of “1E-5” in view of the chip size and the remedy method, the worst data retention time of the memory cell can be calculated from a 1E-5% point on the vertical axis. That is, the number of failed bits at any data retention time tREF(s) can be obtained. As a result, the performance of the memory array under a certain input parameter setting condition can be evaluated based on the total number of failed bits.

Of course, needless to say, the output means in FIGS. 11 and 14 may be provided simultaneously. In that case, both of the number of failed bits and their causes can be cleared up at any data retention time tREF, and the problem with the failed bits and its effective improvement measure can be obtained simultaneously. For example, in the case where the number of failed bits is 105 bits at a data retention time of 5 ms or less, if the analysis is made by providing together the output means as shown in FIG. 11, it becomes clear that the cause of the failed bit is the leakage current and, by reducing the fluctuation in leakage currents, the number of failed bits can be reduced to 10³ bits, for example.

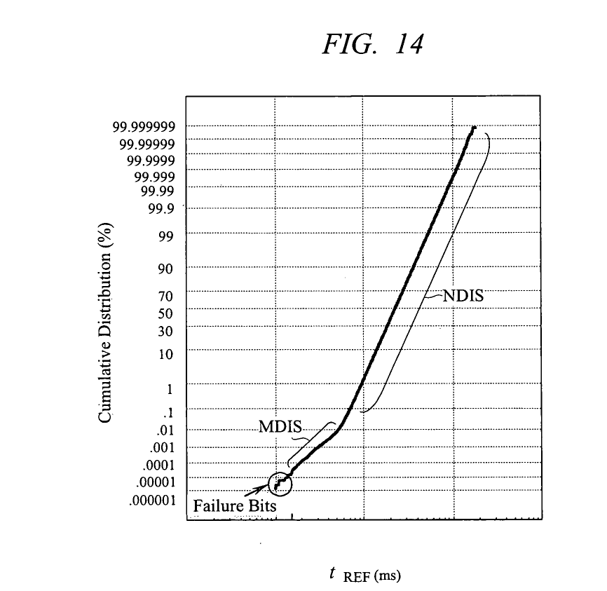

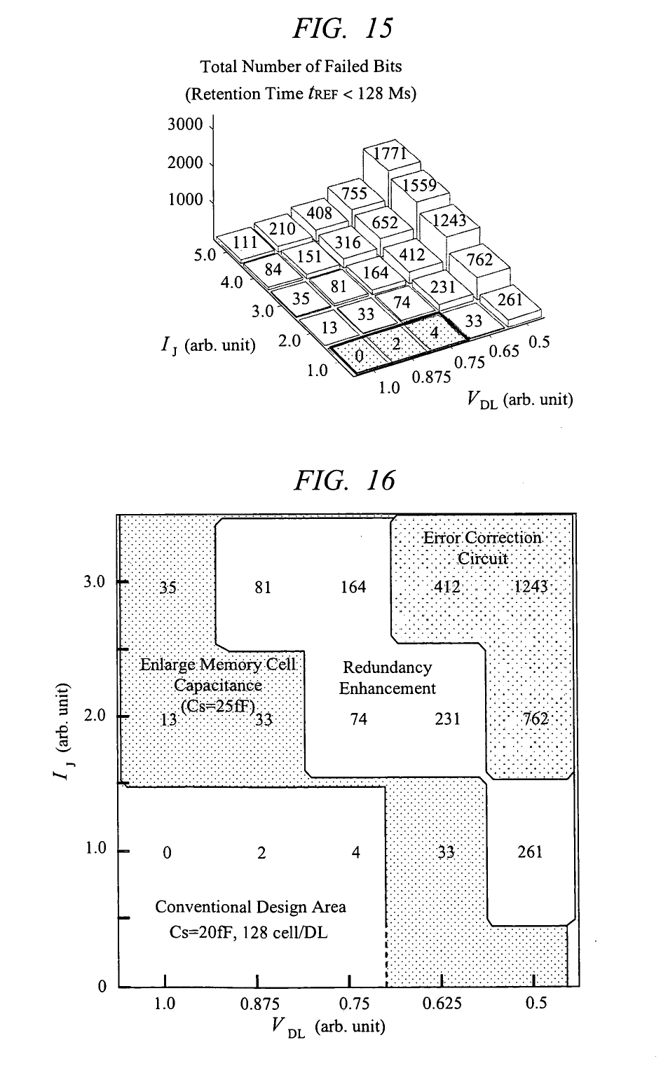

FIG. 15 is an embodiment of a result obtained by setting input parameters shown in FIG. 6 to various values and by calculating the total number of failed bits. FIG. 15 is a bar graph in which the horizontal axes represent an array voltage VDL and a leakage current IJ serving as input parameters and the vertical axis represents the number of failed bits at a time when the data retention time tREF is 128 ms or less. From this Figure, for example, if the array voltage VDL is set to the design target voltage (1.0 in Figure) and the leakage current is reduced to the maximum allowable current value 1.0 or less, the number of failed bits becomes 0 (zero) bit. Furthermore, it can be seen that even when the array voltage is set to a value lower than the design target value by 25%, the failed bits may be 4 (four) bits at most and the designed array has an excellent low-voltage characteristic. Note that the allowable leakage current as above is about 100 fA according to Non-Patent Document 2 (Minchen chang, et al., “Impact of Gate-Induced Drain Leakage on Retention Time Distribution of 256 Mbit DRAM with Negative Wordline Bias” IEEE Transactions on Electron Devices, April 2003, Vol. 50, No. 4, pp. 1036-1041). Furthermore, the result of FIG. 15 can be used to evaluate the role of each remedy measure in reducing the number of failed bits, for example, as shown in FIG. 16.

FIG. 16 is an embodiment showing a specific example of a measure to remedy the failed cells based on the number of failed bits obtained from the approach according to the present invention. As shown in FIG. 16, in the case where the memory cell capacity CS is 20 fF and the number of cells on the data line is 128, if the array voltage VDL is set to a design target value (1.0 in Figure) and the leakage current is set to a maximum allowable current value of 1.0 or less, the total number of failed bits becomes sufficiently small and the chip used therein becomes a good chip. Therefore, it is understood that any new technique for reducing the number of failed bits is not necessary. It is also understood that when the maximum value of the leakage current is twice more than the maximum allowable current value or when the array voltage VDL is lower by 37.5% than the design target voltage, the memory cell capacity CS is required to be increased by 5 fF. Under other conditions, in order to reduce the number of failed bits, an increase in the redundancy bits or a technique such as an error correction circuit may be necessary. Thus, the memory array can be quantitatively evaluated by providing a means of statistically modeling the distribution of the device characteristics parameters, introducing the model to the memory array design, and calculating the total number of failed bits.

### Second Embodiment

In the above-mentioned first embodiment, the case of applying the design approach according to the invention to the DRAM design has been described. However, the first embodiment may be applied to a static random access memory (hereinafter referred to as “SRAM”).

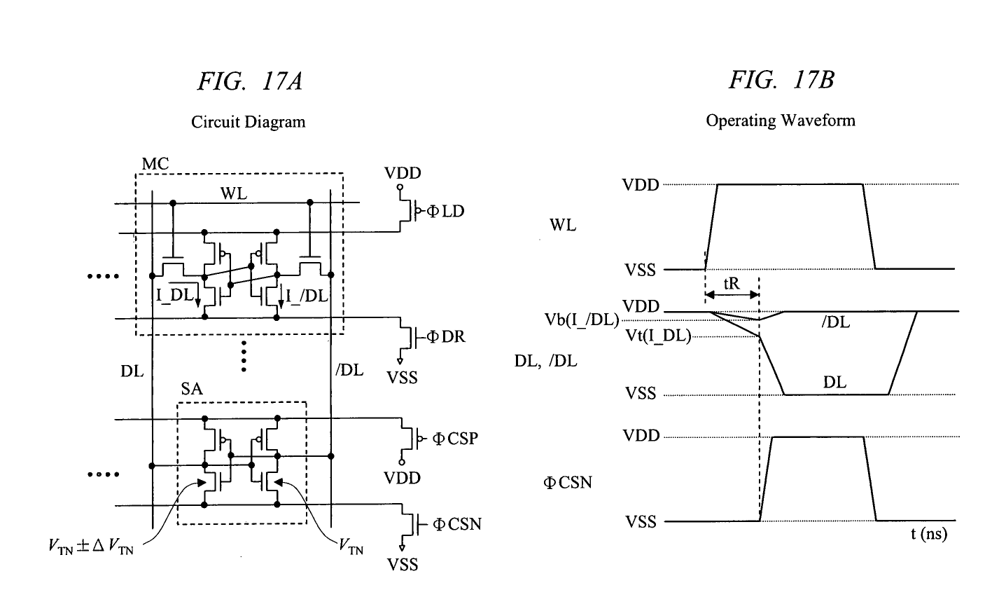

FIGS. 17A and 17B are views for explaining the case of applying the design approach according to the present invention to the SRAM, wherein FIG. 17A shows an example of a circuit diagram of the SRAM and FIG. 17B shows an example of its operating waveform. Reference symbols in the Figure are as follows. That is, “VDD” represents a supply voltage, “ΦLD” a load transistor drive switch, “ΦDR” a driver transistor drive switch, “ΦCSN” and “ΦCSP” common sources, and “I_DL” a H-side readout current, “I_/DL” an L-side off current, “Vt(I_DL)” a H-side data-line voltage by the read-out current I_DL, and “Vb(I_/DL)” an L-side data line voltage by the off leakage current I_/DL. Other reference symbols are similar to those in the first embodiment. A general driving method is used as a driving method for each circuit for performing a read-out or write-in operation of the memory, so that its detailed explanation will be omitted.

In the case of applying the design approach according to the present invention to the SRAM, if a voltage difference between the data lines “Vb(I_/DL)-Vt(I_DL)” is bigger than the sense amplifier offset voltage ΔVTN during a time tR from actuation of a word line WL to activation of the sense amplifier caused by the common source switch ΦCSN (i.e., “Vb(I_/DL)-Vt(I_/DL)”>“ΔVTN”) then the data of the selected memory cell MC can be read-out correctly.

First, on a stage of setting the input parameters, the H-side read-out current I_DL and the L-side off leakage current are set to a distribution suitable for the respective current characteristics (e.g. log-normal distribution), and the offset voltage is set to a distribution which can reproduce the characteristics (e.g. normal distribution). Next, each device parameter value is randomly generated so as to follow each distribution. Then, the device parameter values are substituted into the above conditional equation, whereby it is determined whether the read-out operations can be performed to all the memory cells and/or whether the read-out false operation occurs.

Thus, the total number of failed bits can be obtained by applying the design approach according to the invention to the SRAM. Therefore, the designed array can be evaluated more accurately than the conventional worst-case design. Additionally, if a means of displaying each device characteristic value is provided as an output means, the cause of the failure can be identified, thereby making it possible to reduce significantly the period of time necessary for rearrangement.

Note that this embodiment has described the example in which the voltage difference between the data lines after a specified time is formulated for analysis, but the present invention is not limited to the above embodiment. The design approach according to the present invention may be applied to an analysis of a so-called static noise margin. Also, in the above embodiment, the example in which the statistical distribution is set as an input device parameter has been described. However, needless to say, any physical equation representing each device parameter may be applicable. In this case, if the fluctuation in device parameters such as channel length or channel width is set to, for example, a normal distribution, the distribution of the device parameters can be reproduced accurately. Alternatively, the results experimentally measured may be used as the device parameter values serving as the input parameters without change. If such a manner is used, the designed array can be quantitatively evaluated even when the formulation for representing the distribution is difficult.

### Third Embodiment

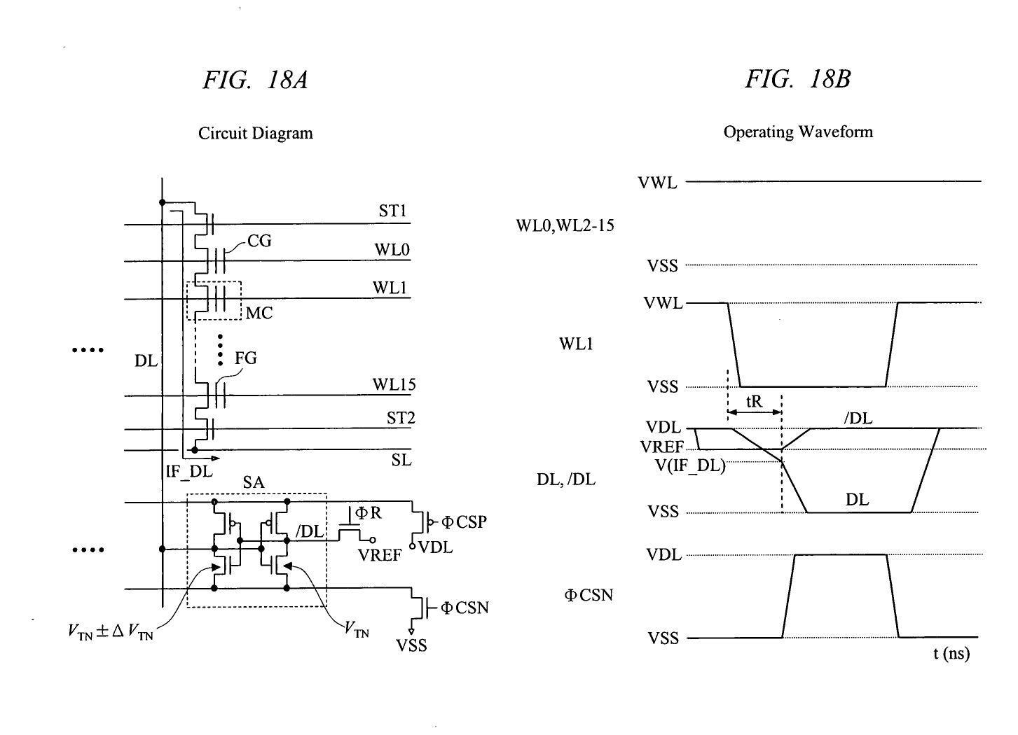

FIGS. 18A and 18B are views for explaining the case of applying the design approach according to the present invention to a NAND-type non-volatile memory, wherein FIG. 18A is an example of a circuit diagram of the NAND-type non-volatile memory and FIG. 18B is an example of its operating waveform.

Reference symbols in the Figure are as follows. That is, “ST1” represents a data line connection switch, “CG” a control gate, “FG” a floating gate, “ST2” a source line selection switch, “SL” a source line, “ΦR” a reference power supply drive switch, “VREF” a reference voltage, “IF_DL” a read-out current, and “V(IF_DL)” a data line voltage by the read-out current IF_DL. Since each circuit diagram or driving method for performing the read-out and write-in operation of the memory cell can be realized by using the commonly known circuit diagram or driving method, their detailed descriptions and drawings will be omitted. Additionally, the design approach according to the present invention is not limited to the above diagram and may be applied to various circuit diagrams.

Note that the sense amplifier circuit SA shown in FIG. 18A has a circuit diagram employing a constant reference voltage, but the reference voltage VREF may be omitted therein. In that case, the total number of failed bits can be calculated if a logic threshold of a transistors configuring the sense amplifier circuit SA and the data line voltage V(IF_DL) are used for formulation.

A NAND type FLASH memory is a gain cell similar to the SRAM. Therefore, if a relationship between the voltage difference between data lines and the offset voltage satisfies the equation “VREF−V(IF_DL)>ΔVIN” during the time tR from assertion of the word line WL1 to the activation of the sense amplifier made by the common source drive switch ΦCSN, then the data of the selected memory cell MC can be read-out accurately. Since the method of making an evaluation of whether the memory cell is defective or good is the same as that explained in the first and second embodiments, its detailed description will be omitted.

As mentioned above, by using the design approach according to the present invention, the designed array in the NAND-type FLASH memory can be quantitatively evaluated. Additionally, by providing a means of displaying the device characteristic values serving as input parameters, the cause of the failed bits can be identified and the period of time necessary for the rearrangement can be significantly reduced.

From the foregoing description, representative structures and effects of the design methodology and manufacturing method for semiconductor memory and the semiconductor design device, which have been described in the above first to third embodiments, can be summarized as follows.

The semiconductor design device according to the present invention is provided with a means of analyzing the memory cell parameters in view of the statistical distribution of each device parameter and of evaluating the designed memory array based on the total number of failed bits in the memory cell calculated by the analysis. Therefore, the designed memory array can be evaluated quantitatively, and the guideline of such array design as to satisfy the desired performance requirement can easily be obtained. Furthermore, by formulating the read-out signal Vsig of the memory cell, the failed bits can be profiled, so that the device parameter required for rearrangement can easily be specified.

As described above, facilitation of the design processing can be realized and the design period can be reduced. Note that, needless to say, the present invention is not limited to the above first to third embodiments and may be variously modified within the scope of not departing from the gist thereof.

For example, in FIG. 6, the array voltage VDL, the memory cell capacity CS, the supply voltage drop ΔVBDL, etc. are used as input parameters. However, the threshold voltage VTH of the cell transistor, a sub-threshold voltage leakage current IOFF flowing in a channel in the cell transistor, and a capacitor leak current ICS flowing in a cell capacitor, etc. may be used as input parameters. In this case, a so-called disturb defect occurring when the data line voltage becomes the ground voltage VSS along with write-in operations of the adjacent cells and when the influence of the leakage current between cell capacitors on the data retention time tREF can be clarified.

Alternatively, a channel impurity concentration, a substrate impurity concentration, or the like may be set as an input parameter. In this case, since the substrate constant can be formulated, an influence of a substrate applying voltage VBB on the data retention time tREF can be quantified. If the influence of the substitute voltage on the data retention time tREF can be quantified, a memory cell voltage can be set optimally. Thus, since the unnecessarily high or low voltage is not required to be applied to the memory cell, the reduction of the percents of failed cells can be realized along with reliability improvement. Furthermore, the device parameters may be set to such a distribution so as to reproduce all device parameters of a chip, wafer, and lot.

Thus, in the design approach according to the present invention, many input parameters can be set depending on the purpose. Also, although the design of the DRAM of one transistor type has been described in the first embodiment, the design approach of the present invention is not limited to this application. Such an application may be a twin cell of two-transistor type or be an OR cell in which two DRAM cells of one transistor type are added logically. Furthermore, needless to say, the present invention may be applied to a DRAM of three-transistor type.

In addition, the case where the present invention is applied to the so-called SRAM of six-transistor type has been described in FIGS. 17A and 17B. However, it may be applied to a SRAM of four-transistor type. Also, the case where the present invention is applied to a NAND-type FLASH memory has been described in FIGS. 18A and 18B. However, needless to say, it may be applied to a NOR-type FLASH memory or a so-called AG-AND type FLASH memory. Furthermore, the present invention may be applied to a phase change memory comprising a chalcogenide film and one access transistor. For each memory, the input parameters necessary for the desirable circuit characteristics and the distribution shape thereof are appropriately selected so as to be adapted to the actual device characteristics, and the desirable circuit performance is formulated so as to be appropriately expressed. Therefore, the array design of various memory cells can be evaluated quantitatively. Thus, the design approach according to the present invention can be variously modified and altered based on the memory cell to be analyzed.

What is claimed is:

1. A manufacturing method for a semiconductor memory, the method comprising the steps of:
designing a memory array containing a memory cell;
verifying said designed memory array; and
forming said verified memory array on a semiconductor wafer, wherein the step of verifying said memory array includes:
a first step of determining, with respect to a plurality of parameters each serving as a component for defining a characteristic of said memory cell and having a statistical distribution by assuming each manufacture fluctuation, each value of the parameters based on a random number in the distribution per set of said plurality of parameters;
a second step of providing a formula defining the characteristic of said memory cell, and applying the value of each of said determined parameters to said formula to calculate the characteristic of said memory cell;
a third step of determining quality of said memory cell based on the characteristic of said calculated memory cell; and
a forth step of performing said first to third steps to each of a plurality of memory cells said memory array contains.

2. The manufacturing method for a semiconductor memory according to claim 1, further comprising a fifth step of displaying a relationship between a probability density of each parameter value corresponding to said plurality of memory cells and a determination result of the quality of said plurality of memory cells, which are obtained in said forth step.

3. The manufacturing method for a semiconductor memory according to claim 1,
wherein said semiconductor memory is a SRAM, and
an equation defining the characteristics of said memory cells is a voltage difference between data lines after a certain time elapses from activation of a word line.

4. The manufacturing method for a semiconductor memory according to claim 1,
wherein said semiconductor memory is a flash memory, and
an equation defining the characteristics of said memory cells is a voltage of a data line after a certain time elapses from activation of a word line.

5. A manufacturing method for a semiconductor memory, the method comprising the steps of:
designing a DRAM memory array containing a DRAM memory cell;
verifying said designed DRAM memory array; and
forming said verified DRAM memory array on a semiconductor wafer,
wherein said step of verifying the DRAM memory array includes:
a first step of determining, with respect to a plurality of parameters each serving as a component affected by an increase/decrease in a read-out signal of said DRAM memory cell and having a statistical distribution by assuming each manufacture fluctuation, each value of the parameters based on a random number in the distribution per set of said plurality of parameters;
a second step of providing a formula defining the read-out signal of said DRAM memory cell, and applying the value of each of said determined parameters to said formula to calculate the read-out signal of said DRAM memory cell;
a third step of determining quality of said DRAM memory cell based on the read-out signal of said calculated DRAM memory cell; and
a forth step of performing said first to third steps to each of a plurality of DRAM memory cells said DRAM memory cell contains to calculate the number of good or failed DRAM memory cells in said DRAM memory array.

6. The manufacturing method for a semiconductor memory according to claim 5,
wherein said plurality of parameters include expectation and variance of a threshold voltage of a memory cell transistor, expectation and variance of a leakage current of the memory cell, expectation and variance of capacitance of the memory cell capacitor, and expectation and variance of a difference between threshold voltages of a pair transistor in a sense amplifier.

7. The manufacturing method for a semiconductor memory according to claim 5,
wherein a data retention time of each of said plurality of DRAM memory cells is calculated based on a calculation result of the read-out signal with respect to said plurality of DRAM memory cells, and
a spec value of said data retention time predetermined and said calculated date retention time are compared to calculate the number of good or failed DRAM memory cells in said DRAM memory array.

8. The manufacturing method for a semiconductor memory according to claim 6,
wherein said threshold voltage follows a normal distribution,
the leakage current of said memory cell follows a log-normal distribution, and
a capacitance value of said memory cell follows a normal distribution.

9. The manufacturing method for a semiconductor memory according to claim 6,
wherein a processing of said forth step includes:
first, determining a value of a difference between threshold voltages of a pair transistors in a first sense amplifier by said first step, and then applying said determined value of the difference between the threshold voltages of the first sense amplifier to calculate the read-out signal with respect to the plurality of DRAM memory cells connected to said first sense amplifier, and
next, determining a value of a difference between threshold voltages of a pair transistors in a second sense amplifier by said first step, and then applying said determined value of the difference between the threshold voltages of the first sense amplifier to calculate the read-out signal with respect to the plurality of DRAM memory cells connected to said second sense amplifier.

10. A semiconductor design device realized by using a computer, the device comprising said computer including:
storing preliminary an equation defining a characteristic of a memory cell and a plurality of parameters each serving as a component for defining the characteristic of the memory cell and having a statistical distribution by assuming each manufacture fluctuation;
generating a random number and determining each value of the parameters based on said generated random number from the distribution per set of said stored plurality of parameters;
calculating the characteristic of said memory cell by substituting said determined value of each of the parameters into said stored equation;
determining quality of said memory cell based on said calculation result; and
performing a processing of determining each value of the parameters and a processing of calculating the characteristic of said memory cell and determining the quality of said memory cell by the number of times equal to that of memory cells preset.

11. The semiconductor design device according to claim 10,
wherein the computer further includes outputting, as a result of calculating the characteristics by the number of times equal to that of said preset memory cells, a statistical distribution representing a relationship between each value of said parameters and a determination result of quality corresponding to the value of each of said parameters.
